(19) United States
(12) Patent Application Publication
(10) Pub. No.: US 2026/0271051 A1
(43) Pub. Date: Sep. 10, 2026

(54) METHODS, APPARATUSES AND SYSTEMS FOR SWITCHING NPCA PRIMARY CHANNEL

(71) Applicant: InterDigital Patent Holdings, Inc., Wilmington, DE (US)

(72) Inventors: Mahmoud Saad, L’Ile Bizard, Montreal (CA); Hanqing Lou, Syosset, NY (US); Ying Wang, Easton, PA (US); Xiaofei Wang, North Caldwell, NJ (US); Joseph Levy, Merrick, NY (US); Rui Yang, Greenlawn, NY (US)

(21) Appl. No.: 19/073,540

(22) Filed: Mar. 7, 2025

(51) Int. Cl. H04W 74/00; H04W 74/08

(52) U.S. Cl. CPC H04W 74/002; H04W 74/08

(57) ABSTRACT

Methods, apparatuses, devices, and computer program products for changing NPCA primary channel are described. A non-AP STA transmits, to an AP, a first frame including a first non-primary channel access, NPCA, information field including a first capability subfield that includes information indicative of a capability of the non-AP STA to switch from a basic service set, BSS, primary channel to a NPCA primary channel that lies outside of a current operating channel width of the non-AP STA and that lies within a BSS channel width of the AP, the current operating channel width including the BSS primary channel. The non-AP STA receives a management frame including a second NPCA information field including a control subfield that indicates enablement information for switching from the BSS primary channel to a specific NPCA primary channel outside the current operating channel width of the non-AP STA, and switches to the specific NPCA primary channel.

### TECHNICAL FIELD

The present disclosure is generally directed to the fields of communications, software and encoding, including, for example, to methods, apparatuses, systems directed to switching NPCA primary channel.

### SUMMARY

In a first aspect, the present principles are directed to a method at a non-access point, non-AP, station, STA, the method including transmitting, to an AP, a first frame including a first non-primary channel access, NPCA, information field including a first capability subfield, wherein the first capability subfield includes information indicative of a capability of the non-AP STA to switch from a basic service set, BSS, primary channel to a NPCA primary channel that lies outside of a current operating channel width of the non-AP STA and that lies within a BSS channel width of the AP, the current operating channel width including the BSS primary channel, receiving, from the AP, a second frame including a second NPCA information field including a control subfield, wherein the control subfield indicates enablement information for switching from the BSS primary channel to a specific NPCA primary channel outside the current operating channel width of the non-AP STA, and switching to the specific NPCA primary channel.

In embodiments, the first frame is one of an association request frame, a reassociation request frame, a probe request frame, a control frame and an action frame.

In embodiments, the second frame is one of an association response frame, a reassociation response frame, a probe response frame, a control frame and an action frame.

In embodiments, the first NPCA information field includes a delay field, the delay field indicating a time delay, wherein the switching to the specific NPCA primary channel is performed within the time delay.

In a second aspect, the present principles are directed to a non-access point, non-AP, station, STA, including at least one processor configured to transmit, to an AP, a first frame including a first non-primary channel access, NPCA, information field including a first capability subfield, wherein the first capability subfield includes information indicative of a capability of the non-AP STA to switch from a basic service set, BSS, primary channel to a NPCA primary channel that lies outside of a current operating channel width of the non-AP STA and that lies within a BSS channel width of the AP, the current operating channel width including the BSS primary channel, receive, from the AP, a second frame including a second NPCA information field including a control subfield, wherein the control subfield indicates enablement information for switching from the BSS primary channel to a specific NPCA primary channel outside the current operating channel width of the non-AP STA, and switch to the specific NPCA primary channel.

In embodiments, the first frame is one of an association request frame, a reassociation request frame, a probe request frame, a control frame and an action frame.

In embodiments, the second frame is one of an association response frame, a reassociation response frame, a probe response frame, a control frame and an action frame.

In embodiments, the first NPCA information field includes a delay field, the delay field indicating a time delay, wherein the switching to the specific NPCA primary channel is performed within the time delay.

In a third aspect, the present principles are directed to a method performed by an access point, AP, the method including receiving, from a non-AP station, STA, a first frame including a first non-primary channel access, NPCA, information field including a first capability subfield, wherein the first capability subfield includes information indicative of a capability of the non-AP STA to switch from a basic service set, BSS, primary channel to a NPCA primary channel that lies outside of a current operating channel width of the non-AP STA and that lies within a BSS channel width of the AP, the current operating channel width including the BSS primary channel, transmitting, to the non-AP STA, a second frame including a second NPCA information field including a control subfield, wherein the control subfield indicates enablement information for switching from the BSS primary channel to a specific NPCA primary channel outside the current operating channel width of the non-AP STA, and switching to the specific NPCA primary channel.

In embodiments, the first management frame is one of an association request frame, a reassociation request frame, a probe request frame, a control frame and an action frame.

In embodiments, the second management frame is one of an association response frame, a reassociation response frame, a probe response frame, a control frame and an action frame.

In embodiments, the first NPCA information field includes a delay field, the delay field indicating a time delay, wherein the switching to the specific NPCA primary channel is performed within the time delay.

In a fourth aspect, the present principles are directed to an access point, AP, including at least one processor configured to receive, from a non-AP station, STA, a first frame including a first non-primary channel access, NPCA, information field including a first capability subfield, wherein the first capability subfield includes information indicative of a capability of the non-AP STA to switch from a basic service set, BSS, primary channel to a NPCA primary channel that lies outside of a current operating channel width of the non-AP STA and that lies within a BSS channel width of the AP, the current operating channel width including the BSS primary channel, transmit, to the non-AP STA, a second frame including a second NPCA information field including a control subfield, wherein the control subfield indicates enablement information for switching from the BSS primary channel to a specific NPCA primary channel outside the current operating channel width of the non-AP STA, and switch to the specific NPCA primary channel.

In embodiments, the first management frame is one of an association request frame, a reassociation request frame, a probe request frame, a control frame and an action frame.

In embodiments, the second management frame is one of an association response frame, a reassociation response frame, a probe response frame, a control frame and an action frame.

In embodiments, the first NPCA information field includes a delay field, the delay field indicating a time delay, wherein the switching to the specific NPCA primary channel is performed within the time delay.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1 illustrates a UHR Operation element;

FIG. 2 illustrates a UHR Operation Parameters field;

FIG. 3 illustrates a NPCA Operation Information field of the UHR Operation element;

FIG. 4 illustrates an example format of the Non-AP STA NPCA Operation Capabilities Information field according to the present principles;

FIG. 5 illustrates schematically the different delays: NPCA switch delay, NPCA switch back delay, NPCA SOOC switch delay, and NPCA SOOC switch back delay;

FIG. 6 illustrates an example Advanced NPCA Operation Information field format for NPCA SOOC Operation;

FIG. 7 illustrates a first embodiment of a method of NPCA operation for a non-AP STA that supports SOOC according to the present principles;

FIG. 8 illustrates a second embodiment of a method of NPCA operation for a non-AP STA that supports SOOC according to the present principles;

FIG. 9 illustrates an example NPCA Operation Request Action frame;

FIG. 10 illustrates an example Advanced NPCA Operation Information field for announcing NPCA PCH change;

FIG. 11 illustrates a first method at the NPCA AP for changing of the NPCA Primary Channel according to an embodiment of the present principles;

FIG. 12 illustrates an example of NPCA PCH change according to an embodiment of the present principles;

FIG. 13 illustrates an example of NPCA PCH change according to an embodiment of the present principles;

FIG. 14 illustrates a second method at the NPCA AP for changing of the NPCA Primary Channel according to an embodiment of the present principles

FIG. 15 illustrates an example of NPCA operation for NPCA non-AP STAs with different operating channel widths; and

FIG. 16 illustrates an example Advanced NPCA Operation Information field format for NPCA PCH change Operation.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Overview of Wireless Local Area Network (WLAN) Systems

A WLAN [see IEEE Std 802.11™-2020: Wireless LAN Medium Access Control (MAC) and Physical Layer (PHY) Specifications] in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA. Such traffic between STAs within a BSS is really peer-to-peer traffic. Such peer-to-peer traffic may also be sent directly between the source and destination STAs with a direct link setup (DLS) using an 802.11e DLS or an 802.11z tunneled DLS (TDLS). A WLAN using an Independent BSS (IBSS) mode has no AP and the STAs are communicating directly with each other. This mode of communication is referred to as an “ad-hoc” mode of communication and is possible when IEEE 802.11 STAs are able to communicate directly. This type of IEEE 802.11 LAN is often formed without preplanning.

Using the 802.11ac infrastructure mode of operation, the AP may transmit a Beacon on a fixed channel, usually the primary channel. This channel may be 20 MHz wide and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, senses (i.e. detects) the occupancy or vacancy of the primary channel. If the channel is detected to be busy, the STA backs off. Hence only one STA may transmit at any given time in a given BSS.

In 802.11n [see IEEE Std 802.11™-2020: Wireless LAN Medium Access Control (MAC) and Physical Layer (PHY) Specifications], High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac [see IEEE P 802.11ax™/D8.0: Wireless LAN Medium Access Control (MAC) and Physical Layer (PHY) Specifications], Very High Throughput (VHT) STAs may support 20 MHz, 40 MHz, 80 MHz, and 160 MHz wide channels. The 40 MHz and 80 MHz channels are formed by combining contiguous 20 MHz channels similar to 802.11n, already described. A 160 MHz channel may be formed either by combining 8 contiguous 20 MHz channels or by combining two non-contiguous 80 MHz channels, where the latter may be referred to as an 80+80 configuration. For the 80+80 configuration, at the transmitter, the data, after channel encoding, is passed through a segment parser that divides it into two streams. Inverse Fast Fourier Transform (IFFT) and time domain processing are performed on each stream separately. The streams are then mapped on to the two channels, and the data is transmitted. At the receiver, this mechanism is reversed, and the combined data is sent to the MAC.

Sub 1 GHz modes of operation are supported by 802.11af [see IEEE P 802.11be™/D3.0: Wireless LAN Medium Access Control (MAC) and Physical Layer (PHY) Specifications, January 2023] and 802.11ah [see IEEE P 802.11bn™/D0.1: Wireless LAN Medium Access Control (MAC) and Physical Layer (PHY) Specifications, February 2025]. For these specifications, the channel Operating Channel widths and carriers are reduced relative to those used in 802.11n and in 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. A possible use case for 802.11ah is support for Meter Type Control (MTC) devices in a macro coverage area. MTC devices may have limited capabilities including support for limited bandwidths but also include a requirement for a very long battery life.

WLAN systems that support multiple channels and channel widths, such as 802.11n, 802.11ac, 802.11af, and 802.11ah, include a channel that is designated as the primary channel. The primary channel may have a bandwidth equal to the largest common Operating Channel width supported by all STAs in the BSS. The bandwidth of the primary channel is therefore limited by the STA that supports the smallest bandwidth operating mode among all the STAs operating in a BSS. In the example of 802.11ah, the primary channel may be 1 MHz wide if there are STAs (e.g. MTC type devices) that only support a 1 MHz mode even if the AP and other STAs in the BSS support 2 MHz, 4 MHz, 8 MHz, 16 MHz, or other channel bandwidth operating modes. All carrier sensing and NAV settings depend on the status of the primary channel; i.e., if the primary channel is busy, for example, due to a STA supporting only a 1 MHz operating mode transmitting to the AP, then the entire available frequency bands are considered busy even though majority of it stays idle and available.

In the United States, the available frequency bands which may be used by 802.11ah are from 902 MHz to 928 MHz. In Korea it is from 917.5 MHz to 923.5 MHz; and in Japan, it is from 916.5 MHz to 927.5 MHz. The total bandwidth available for 802.11ah is 6 MHz to 26 MHz depending on the country code.

The IEEE 802.11 Ultra High Reliability (UHR) Study Group (SG) was formed in September 2022. UHR is considered as the next major revision to IEEE 802.11 standards following 802.11be, which is currently in the Working Group Letter Ballot Stage. UHR is formed to explore the possibility to improve reliability, support low latency traffic and further increase peak throughput and improve efficiency of the IEEE 802.11 networks. Secondary channel access was discussed in 802.11bn and UHR SG.

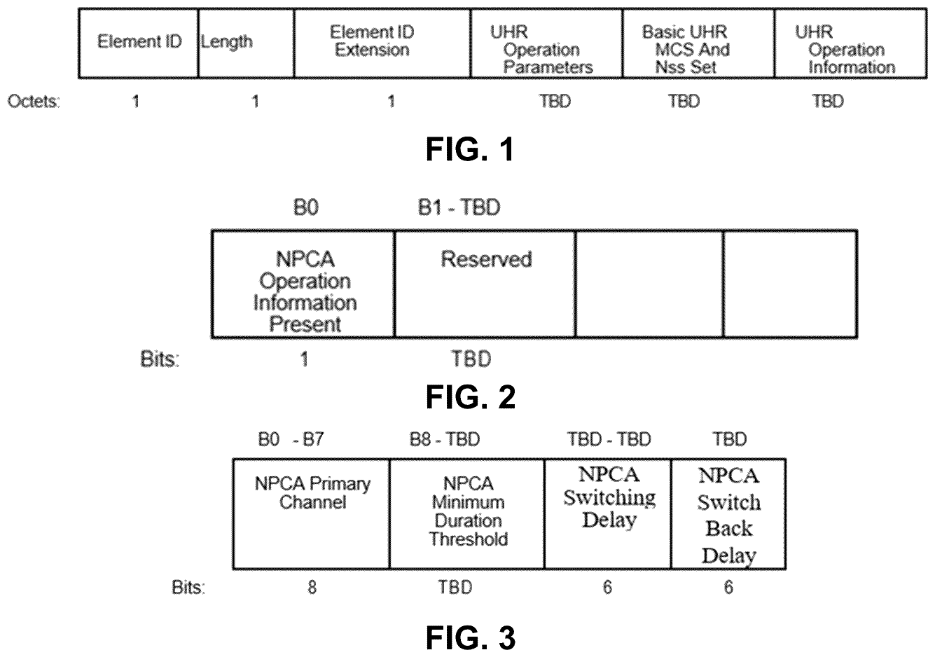

A STA that supports Non-Primary Channel Access (NPCA) operation is called a NPCA STA. An AP that supports NPCA operation is called a NPCA AP. FIG. 1 illustrates a UHR Operation element including a UHR Operations Parameters field. FIG. 2 illustrates a UHR Operations Parameters field including a NPCA Operation Information Present field that indicates whether NPCA operation is enabled at the AP transmitting this field and whether a NPCA Operation Information field (illustrated in FIG. 3) is present in the UHR Operation Information field of the UHR Operation element [see IEEE P802.11bn™/D0.1: Wireless LAN Medium Access Control (MAC) and Physical Layer (PHY) Specifications, February 2025].

In NPCA operation, the NPCA AP and the NPCA non-AP STAs may switch to another designated primary channel (which is different from the regular primary channel known as the BSS primary channel) when the BSS primary channel is busy due to overlapping BSS (OBSS) transmission. The NPCA AP announces the designated primary channel (aka NPCA primary channel, secondary channel, anchor channel, or non-primary channel) in the NPCA Operation Information field [see FIG. 3] in the UHR Operation element in the Beacon frame it transmits.

In the NPCA Operation Information field illustrated in FIG. 3, the NPCA Primary Channel field indicates the channel number of a channel within the BSS bandwidth, the NPCA Minimum Duration Threshold field indicates the minimum duration of inter-BSS activity (inter-BSS PPDU or inter-BSS Transmission Opportunity (TXOP)) that is required have been indicated on the primary channel of the BSS as a necessary condition to permit a NPCA STA to switch to the NPCA primary channel to perform NPCA operation, the NPCA Switch Delay field indicates the time needed by a NPCA STA to switch from the BSS primary channel to the NPCA primary channel, and the NPCA Switch Back Delay field indicates the time needed by a NPCA STA to switch from the NPCA primary channel to the BSS primary channel.

In NPCA, the AP and non-AP STAs switch from the primary channel to the NPCA primary channel if the primary channel is busy due to an OBSS transmission. Some non-AP STAs are capable of switching from the BSS primary channel to the NPCA primary channel if the NPCA primary channel is outside the operating channel width of those STAs (i.e. outside of the channel width in which the STAs are currently able to receive, and within the associated AP's BSS channel width). It is desirable to enable non-AP STAs that are able to switch outside their operating channel width to participate in NPCA operation. However, this is not possible using conventional Wi-Fi solutions.

Further, a NPCA AP may need to change the NPCA primary channel it announces for NPCA operation in the Beacon frame. In this case, if a NCPA non-AP STA is not aware of the change due to being in a doze mode when the change takes place, it may not be able to update its NPCA operating parameters. This may lead to unmanageable behavior from the non-AP STA that may interrupt the smooth operation of NPCA. However, conventional Wi-Fi solutions provide no solution to this.

In a first embodiment of the present principles, NPCA is provided for STAs with the capability to switch to a NPCA PCH outside their Operating Channel width.

A NPCA non-AP STA that supports the capability to switch to a NPCA PCH outside its Operating Channel width may announce this capability and associated parameters in a Non-AP STA NPCA Operation Capabilities Information field or in another field in the NPCA Non-AP STA Operation Capabilities element that is sent in the Request frame (a first type of management frame; herein an expression covering at least one of Association Request frame, Reassociation Request frame, and Probe Request frame) or in another frame that may carry capabilities information elements from the NPCA non-AP STA to the NPCA AP STA.

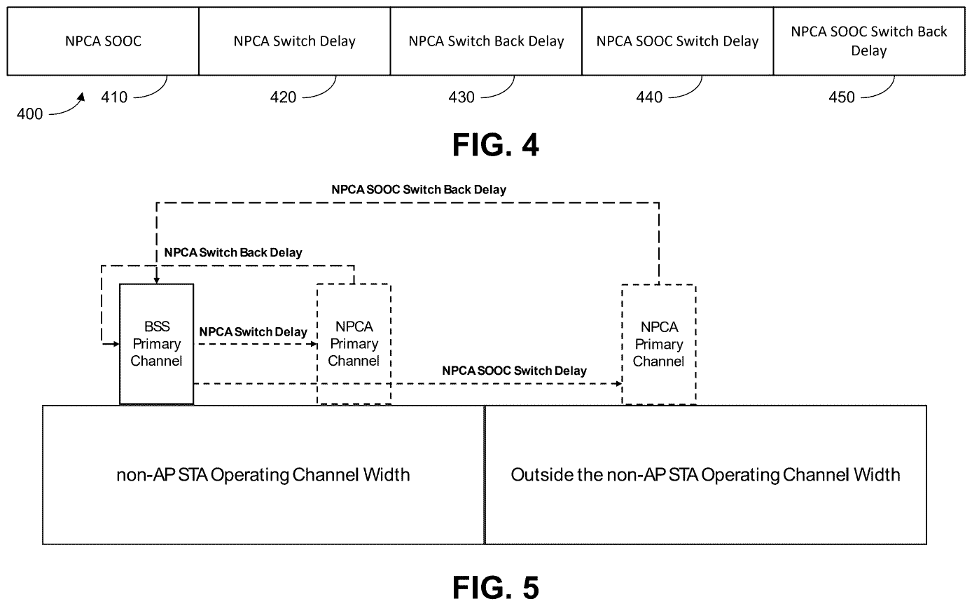

FIG. 4 illustrates an example format of the Non-AP STA NPCA Operation Capabilities Information field 400 according to the present principles. The Non-AP STA NPCA Operation Capabilities Information field 400 can include a NPCA Switching Outside Operating Channel width (NPCA SOOC) field 410, a NPCA switch delay field 420, a NPCA switch back delay field 430, a NPCA SOOC switch delay field 440, and a NPCA SOOC switch back delay field 450.

The NPCA SOOC field 410 indicates whether the NPCA non-AP STA supports switching to a NPCA PCH outside its Operating Channel width. The NPCA SOOC field is set to a value (such as 1) if the NPCA non-AP STA supports switching to a NPCA PCH outside its Operating Channel width and set to another value (such as 0) if the NPCA non-AP STA does not support switching to a NPCA PCH outside its Operating Channel width.

The NPCA Switch Delay field 420 indicates the time needed by a NPCA non-AP STA to switch from the BSS primary channel to the NPCA primary channel if the NPCA primary channel is inside its Operating Channel width.

The NPCA Switch Back Delay field 430 indicates the time needed by the NPCA non-AP STA to switch from the NPCA primary channel to the BSS primary channel if the NPCA primary channel is inside its Operating Channel width.

If the NPCA non-AP STA supports SOOC, the NPCA SOOC Switch Delay field 440 indicates the time needed by a NPCA non-AP STA to switch from the BSS primary channel to the NPCA primary channel outside its Operating Channel width in given units of time (e.g. 4 μs). If the NPCA non-AP STA does not support Switching Outside Operating Channel width (SOOC) capability, the NPCA SOOC Switch Delay field is set to a reserved value.

If the NPCA non-AP STA supports (SOOC), the NPCA SOOC Switch Back Delay field 450 indicates the time needed by a NPCA non-AP STA to switch from the NPCA primary channel back to the BSS primary channel outside its Operating Channel width in given units of time (e.g. 4 μs). If the NPCA non-AP STA does not support Switching Outside Operating Channel width (SOOC) capability, the NPCA SOOC Switch Back Delay field is set to a reserved value.

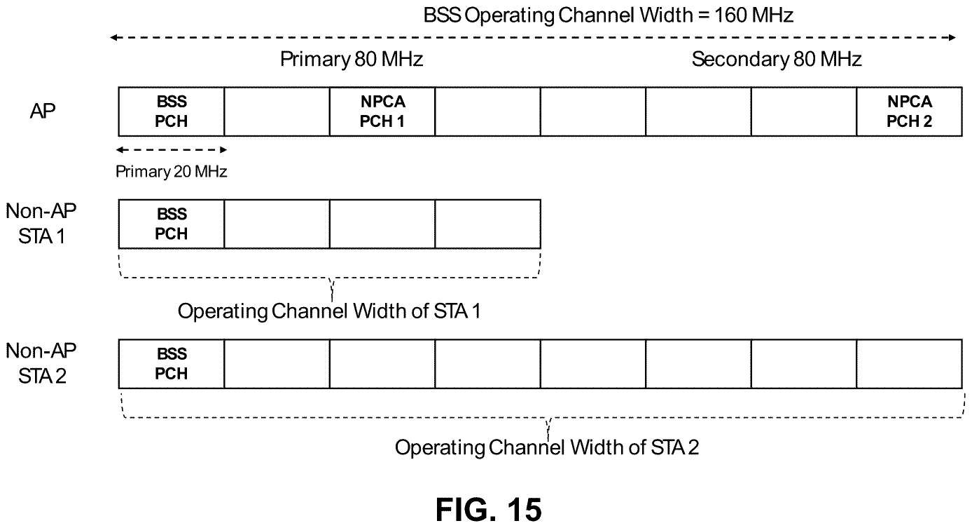

FIG. 15 illustrates an example of NPCA operation for NPCA non-AP STAs with different operating channel widths. In this example, the BSS operating channel width is 160 MHz, the operating channel width of STA1 is 80 MHz and the operating channel width of STA2 is 160 MHz. The BSS primary channel (the primary 20 MHz) is the lowest 20 MHz in the primary 80 MHz. In case the AP announces NPCA PCH1 as the NPCA primary channel, both STA1 and STA2 can switch inside their operating channel width to the announced NPCA primary channel. However, in case the AP announces NPCA PCH2 as the NPCA primary channel, STA2 can still switch inside its operating channel width to the announced NPCA primary channel, while STA1 must switch outside its operating channel width (by switching to another center frequency) to the announced NPCA primary channel.

FIG. 5 illustrates schematically the different delays: NPCA switch delay, NPCA switch back delay, NPCA SOOC switch delay, and NPCA SOOC switch back delay. The NPCA switch delay is the time it takes to switch from the BSS Primary Channel to a NPCA Primary Channel inside the NPCA non-AP STA's Operating Channel width and the NPCA switch back delay is the time it takes to switch back, while the NPCA SOOC switch delay is the time it takes to switch from the BSS Primary Channel to a NPCA Primary Channel outside the NPCA non-AP STA's Operating Channel width and the NPCA SOOC switch back delay is the time it takes to switch back.

As mentioned, the NPCA non-AP STA may announce its NPCA operating parameters and/or NPCA SOOC parameters by sending the Non-AP STA NPCA Operation Capabilities Information field in the NPCA non-AP STA Operation Capabilities element in the Request frame.

The NPCA non-AP STA may set the NPCA SOOC field to a value (such as 1) to indicate that it supports NPCA SOOC, and it may set the NPCA SOOC field to another value (such as 0) to indicate that it does not support NPCA SOOC.

If the NPCA non-AP STA supports NPCA SOOC, it can set the NPCA Switch Delay field to the time needed to switch from the BSS primary channel to the NPCA primary channel inside its Operating Channel width in in given units of time (e.g. 4 μs).

If the NPCA non-AP STA supports NPCA SOOC, it can set the NPCA Switch Back Delay field to the time needed to switch from the NPCA primary channel inside its Operating Channel width to the BSS primary channel in in given units of time (e.g. 4 μs).

If the NPCA non-AP STA supports NPCA SOOC, it can set the NPCA SOOC Switch Delay field to the time needed to switch from the BSS primary channel to the NPCA primary channel outside its Operating Channel width in in given units of time (e.g. 4 μs).

If the NPCA non-AP STA supports NPCA SOOC, it can set the NPCA SOOC Switch Back Delay field to the time needed to switch from the NPCA primary channel outside its Operating Channel width to the BSS primary channel in in given units of time (e.g. 4 μs).

If the NPCA non-AP STA does not support NPCA SOOC, it can set the NPCA Switch Delay field to the time needed to switch from the BSS primary channel to the NPCA primary channel inside its Operating Channel width in in given units of time (e.g. 4 μs).

If the NPCA non-AP STA does not support NPCA SOOC, it can set the NPCA Switch Back Delay field to the time needed to switch from the NPCA primary channel inside its Operating Channel width to the BSS primary channel in given units of time (e.g. 4 μs).

If the NPCA non-AP STA does not support NPCA SOOC, it can set the NPCA SOOC Switch Delay field to a reserved value and the NPCA SOOC Switch Back Delay field to a reserved value.

Upon reception of the Request sent from the NPCA non-AP STA, the NPCA AP may respond to with a Response frame (a second type of management frame; herein an expression covering at least one of Association Response frame, Reassociation Response frame, and Probe Response frame) containing a UHR Operation element (see FIG. 1) including a NPCA Operation Information field (see FIG. 3) to communicate NPCA operation parameters, such as the NPCA primary channel, NPCA Minimum Duration Threshold, NPCA Switch Delay, NPCA Switch Back Delay.

It may happen that the NPCA Primary Channel selected by the NPCA AP and indicated in the NPCA Operation Information field lies inside the Operating Channel width of certain non-AP STAs and outside the Operating Channel width of other non-AP STAs. The NPCA AP may then act in different ways.

The NPCA AP may disable NPCA SOOC for the NPCA non-AP STAs supporting this. In this case, the NPCA non-AP STAs having the NPCA PCH outside their Operating Channel width will refrain from switching to the NPCA PCH during NPCA operation and may go in a doze mode during the busyness of the primary channel due to an OBSS transmission.

The NPCA AP may enable NPCA SOOC for the NPCA non-AP STAs supporting this. In this case, the NPCA non-AP STAs supporting the SOOC feature may switch to the NPCA PCH during NPCA operation.

The NPCA AP may enable NPCA SOOC for the non-AP STAs whose SOOC switch delay and SOOC switch back delay are smaller than a given value (i.e. a threshold) or comparable to the NPCA switch delay and NPCA switch back delay. NPCA AP may disable NPCA SOOC for the NPCA non-AP STAs that do not meet the criteria.

The NPCA AP may use a field in an Advanced NPCA Operation Information field, herein named SOOC Control, to indicate whether switching outside the Operating Channel width is allowed for the NPCA non-AP STAs which supports this feature.

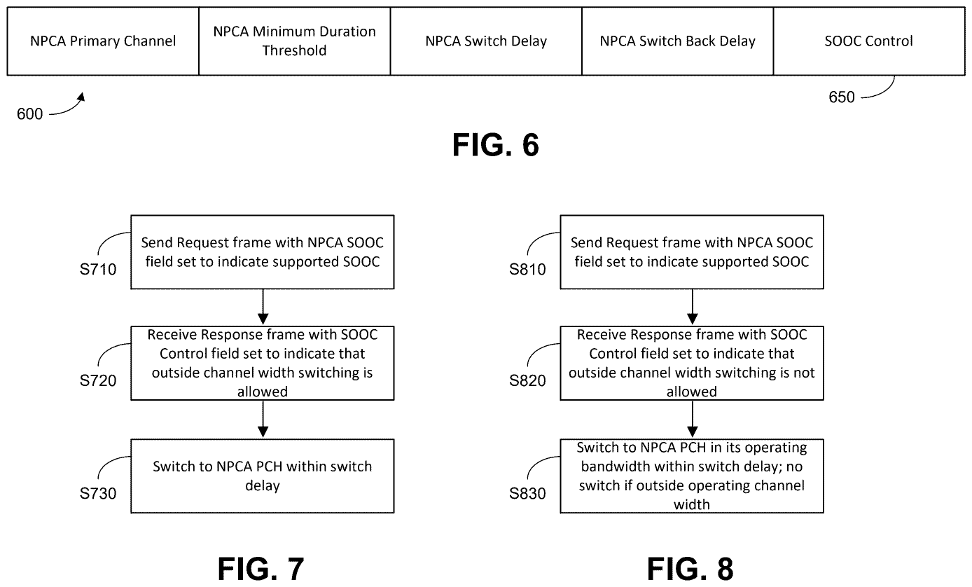

FIG. 6 illustrates an example Advanced NPCA Operation Information field 600 for NPCA SOOC Operation. The Advanced NPCA Operation Information field 600 includes the fields of the NPCA Operation Information field illustrated in FIG. 3 and adds the ‘SOOC Control’ field 650.

In an example, the NPCA AP may set the SOOC Control field 650 to a first value (e.g. 1) to enable SOOC for the NPCA non-AP STA that supports this and set the SOOC Control field to a second value (e.g. 0) to disable the SOOC feature for the NPCA non-AP STAs that supports this.

The NPCA AP can set the SOOC Control field 650 in the Advanced NPCA Operation Information field 600 to a first value (such as 1) to indicate that NPCA non-AP STAs supporting SOOC may switch to the NPCA primary channel if the NPCA primary channel is outside the Operating Channel width of the NPCA SOOC non-AP STA.

The NPCA AP can set the SOOC Control field 650 in the Advanced NPCA Operation Information field 600 to a second value (such as 0) to indicate that NPCA non-AP STAs supporting SOOC may not switch to the NPCA primary channel if the NPCA primary channel is outside the Operating Channel width of the NPCA SOOC non-AP STA.

Additionally, or alternatively, NPCA non-AP STAs supporting SOOC may switch to the NPCA primary channel if the NPCA primary channel is inside the Operating Channel width of the NPCA SOOC non-AP STA regardless of the value of the SOOC Control field in the Advanced NPCA Operation Information field.

FIG. 7 illustrates a first embodiment of a method of NPCA operation for a non-AP STA that supports SOOC according to the present principles.

In step S710, the NPCA non-AP STA sends a Request frame with the NPCA SOOC field in the Non-AP STA NPCA Operation Capabilities Information field set to indicate supported SOOC.

In step S720, the NPCA non-AP STA receives from the NPCA AP STA a Response frame with the SOOC Control field in the Advanced NPCA Operation Information field set to indicate that non-AP STAs that support SOOC are allowed to switch to a NPCA PCH outside its Operating Channel width.

When the BSS primary channel gets busy due to an OBSS transmission, in step S730, the NPCA non-AP STA that supports NPCA SOOC switches to the NPCA PCH within a maximum switch delay upper-bounded by the NPCA SOOC Switch Delay time if the NPCA PCH is outside its Operating Channel width, or switches to the NPCA PCH within a maximum switch delay upper-bounded by the NPCA Switch Delay time if the NPCA PCH is inside its Operating Channel width.

FIG. 8 illustrates a second embodiment of a method of NPCA operation for a non-AP STA that supports SOOC according to the present principles.

In step S810, the NPCA non-AP STA sends a Request frame with the NPCA SOOC field in the Non-AP STA NPCA Operation Capabilities Information field set to indicate supported SOOC.

In step S820, the NPCA non-AP STA receives from the NPCA AP STA a Response frame with the SOOC Control field in the Advanced NPCA Operation Information field set to indicate that non-AP STAs that support SOOC are not allowed to switch to a NPCA PCH outside its Operating Channel width.

When the BSS primary channel gets busy due to an OBSS transmission, in step S830, the NPCA non-AP STA that supports SOOC switches to the NPCA PCH within a maximum switch delay upper-bounded by the NPCA Switch Delay time if the NPCA PCH is inside its Operating Channel width and refrains from switching to the NPCA PCH if the NPCA PCH is outside its Operating Channel width.

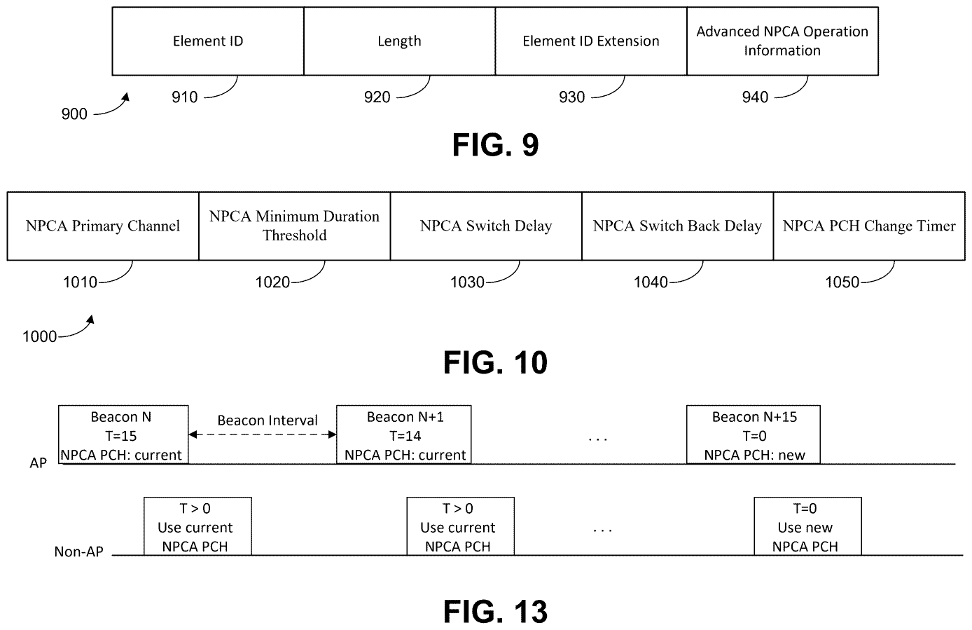

The NPCA AP may send a NPCA Operation Request Action frame to the NPCA non-AP STAs. The NPCA Operation Request Action frame can include a NPCA Operation element. FIG. 9 illustrates an example NPCA Operation Request Action frame 900 that includes an Element ID field 910 and an optional Element ID Extension field 920that identify the NPCA Operation element, a Length field 930 indicating the number of octets in the element excluding the Element ID and Length fields, and the Advanced NPCA Operation Information field 940.

The NPCA AP may use the SOOC Control field in the Advanced NPCA Operation Information field to indicate whether switching outside the Operating Channel width is allowed for the NPCA non-AP STAs to which the NPCA Operation Request Action frame is sent. The NPCA AP may for example set the SOOC Control field to a first value (e.g. 1) to enable NPCA SOOC for the NPCA non-AP STA to which the NPCA Operation Request Action frame is sent and set the SOOC Control field to a second value (e.g. 0) to disable the NPCA SOOC.

In case the NPCA AP set the SOOC Control field in the Advanced NPCA Operation Information field to enable NPCA SOOC, the NPCA non-AP STA supporting SOOC may switch to the NPCA primary channel if the NPCA primary channel is outside the Operating Channel width of the NPCA SOOC non-AP STA. In case the NPCA AP set the SOOC Control field in the Advanced NPCA Operation Information field to disable SOOC, the NPCA non-AP STA supporting SOOC may not switch to the NPCA primary channel if the NPCA primary channel is outside its Operating Channel width.

In case the NPCA non-AP STA accepts the change requested by the NPCA AP, it may respond to the NPCA Operation Request Action frame with NPCA Operation Response Action frame in which the Status Code field for example is set to the value ‘SUCCESS’.

To suggest a different parameter than the one requested by the NPCA AP, the NPCA non-AP STA may respond to the NPCA Operation Request Action frame with a NPCA Operation Response Action frame in which the Status Code field for example is set to the value ‘SUGGEST’.

In case the NPCA non-AP STA rejects the change requested by the NPCA AP, it may respond to the NPCA Operation Request Action frame with NPCA Operation Response Action frame in which the Status Code field for example is set to the value ‘REJECT’.

In a second embodiment of the present principles, Announcement of NPCA PCH Change is enabled.

As already mentioned, the NPCA AP may change the announced NPCA PCH to a different NPCA PCH, for example due to a higher availability for the new NPCA PCH or any other reasons determined by the NPCA AP. The NPCA AP may announce the new NPCA PCH in the NPCA Operation Information field in the UHR Operation element included in the Beacon frame. Some of the NPCA non-AP STAs may miss the latest transmitted Beacon and thus fail to update its NPCA operation parameters.

To address this issue, the NPCA AP may maintain a countdown timer in a field, herein named “NPCA PCH Change Timer,” in an Advanced NPCA Operation Information field in the UHR Operation element included in the Beacon frame. FIG. 10 illustrates an example Advanced NPCA Operation Information field 1000 for announcing NPCA PCH change. The NPCA AP may set the NPCA PCH Change Timer field 1050 to a value (e.g. 0) to indicate that the NPCA PCH either has changed to the channel indicated in the NPCA Primary Channel field 1010 or is not expected to change soon. The NPCA AP may set the NPCA PCH Change Timer field 1050 to a value such as T to indicate that the NPCA PCH indicated in the NPCA Primary Channel field 1010 will be changed after the timer with a value T and indicated in the NPCA PCH Change Timer field 1050 has elapsed. The time T may be measured in a unit of time such as microseconds or milliseconds, but T may also represent a multiple of Beacon intervals (e.g., T=10 Beacon intervals). The Advanced NPCA Operation Information field 1000 can also include fields to carry a NPCA Minimum Duration Threshold, a NPCA Switch Delay and a NPCA Switch Back Delay, which have already been discussed.

The NPCA AP may evaluate the candidate channels within the BSS Operating Channel width to be selected as a NPCA PCH and in case it finds that a NPCA PCH is better (using some evaluation criteria) than the current NPCA PCH, it may set the NPCA PCH Change Timer field to a value T and decrease this value in the NPCA PCH Change Timer field in each Beacon frame it transmits until it reaches a value of 0. The NPCA AP may then change the NPCA Primary Channel field to the new NPCA PCH and keep the NPCA PCH Change Timer field at 0 in an advanced NPCA Operation Information field in the UHR Operation element included in the Beacon frame.

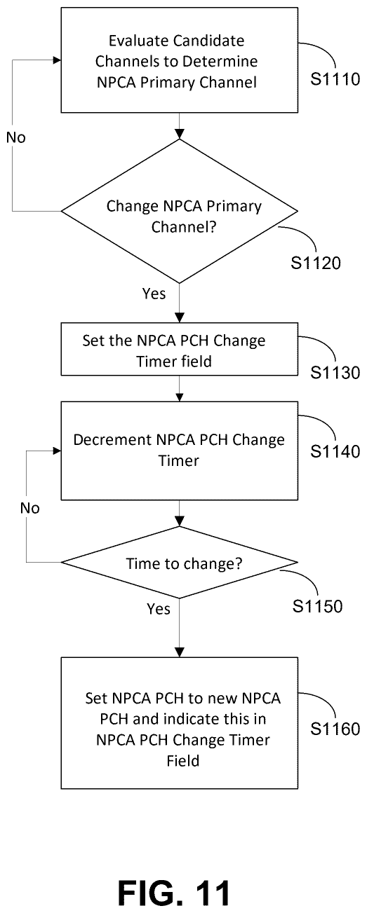

FIG. 11 illustrates a first method at the NPCA AP for changing the NPCA Primary Channel according to an embodiment of the present principles.

In step S1110, the NPCA AP evaluates whether to change from the current NPCA Primary Channel (PCH) to a new NPCA Primary Channel. The NPCA AP evaluates a set of candidate channels (candidate NPCA primary channel list) that satisfy the conditions of NPCA operation. Such conditions can include e.g. being within the BSS bandwidth, not including any of the channels occupied by the inter-BSS traffic that caused the STA to switch from the BSS primary channel to the NPCA primary channel, and not including channels that are indicated as punctured in the Disabled Subchannel Bitmap field in the EHT Operation element. If the NPCA AP, in step S1120, determines that no change is required, it may keep evaluating the current candidate NPCA primary channel list (in step S1110).

If the NPCA AP, in step S1120, determines to change the NPCA Primary Channel, in step S1130, it sets the NPCA PCH Change Timer field in the Advanced NPCA Operation Information field in the NPCA Operation Information field in the UHR Operation element in the Beacon frame to a value (such as T). In one example, the value T is a period measured in a given time unit (such as milliseconds or microseconds). In another example, the value T is measured in terms of numbers of Beacon Intervals. The NPCA AP sets the NPCA Primary Channel field in the Advanced NPCA Operation Information field in the NPCA Operation Information field in the UHR Operation element in the same Beacon frame to the current NPCA PCH.

In step S1140, the NPCA AP decrements the value in the NPCA PCH Change Timer field in the next Beacon frame. It will be appreciated that different ways of updating the timer field may be used instead, such as starting from a negative value and incrementing until a given value (e.g. 0) is reached.

In step S1150, the NPCA AP determines whether it should switch from the current NPCA PCH to the new NPCA PCH. This determination can for example be based on the value in the NPCA PCH Change Timer field being zero, i.e. T=0.

In case the NPCA AP should not yet switch to the new NPCA PCH (i.e. “No”), the method returns to step S1140.

In case the NPCA AP should switch to the new NPCA PCH (i.e. “Yes”), in step S1160, it sets, in the next Beacon frame it transmits, the NPCA Primary Channel field in the Advanced NPCA Operation Information field in the NPCA Operation Information field in the UHR Operation element in the next Beacon frame to the new NPCA Primary Channel and indicates the change by setting the NPCA PCH Change Timer field in the Advanced NPCA Operation Information field in the NPCA Operation Information field in the UHR Operation element to 0.

The AP then maintains the NPCA PCH Change Timer field at 0 and the NPCA Primary Channel field as the new NPCA Primary channel in subsequent Beacon frames until it determines that the NPCA Primary Channel is to be changed.

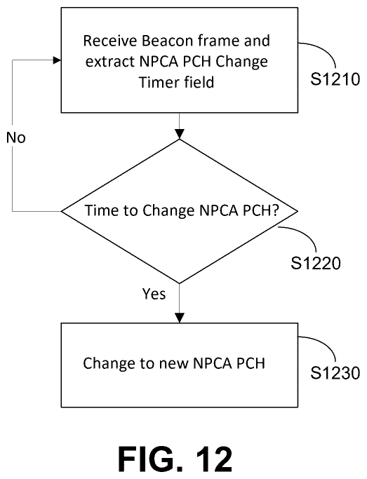

FIG. 12 illustrates a method at the NPCA non-AP STA for changing the NPCA Primary Channel according to an embodiment of the present principles.

In step S1210, the non-AP STA receives the Beacon frame and extracts the NPCA PCH Change Timer.

In step S1220, the non-AP STA determines if it is time to change the NPCA PCH. This is done by determining whether the NPCA PCH Change Timer is equal to a given value (or values), for example 0, which will be used as a non-limitative example. It will be understood that the non-AP STA is configured to mirror the AP STA in the sense that it will determine to switch the NCPA PCH when the AP STA indicates that it is time to switch the NCPA PCH.

If the NPCA PCH Change Timer>0 (i.e. “No”), the non-AP STA keeps using the current NPCA Primary Channel and prepares for the change of the NPCA Primary Channel when the NPCA PCH Change Timer reaches 0. The method then returns to step S1210.

If the NPCA PCH Change Timer equals 0 (i.e. “Yes”), in step S1230, the non-AP switches to the NPCA PCH Channel, i.e. the new NPCA PCH Channel, indicated in the NPCA Primary Channel field in the Advanced NPCA Operation Information field in the NPCA Operation Information field in the UHR Operation element in the Beacon frame.

It is noted that the NPCA AP may set the NPCA PCH Change Timer field to announce the change of the NPCA Primary Channel to a value which guarantees that all NPCA non-AP STAs which are in a doze mode will be back from the doze mode before the NPCA PCH Change Timer reaches 0. The NPCA non-AP STA in a doze mode can read the Beacon frame upon returning from the doze mode to check whether the NPCA PCH Change Timer field has a value greater than 0 or not.

FIG. 13 illustrates an example of NPCA PCH change according to an embodiment of the present principles. In Beacon N, T=15 and the NPCA PCH is set to the current NPCA PCH. The non-AP STA determines that a NPCA PCH change is upcoming (i.e. T>0) and uses the current NPCA PCH. In each subsequent Beacon, the NPCA AP decrements the value T (e.g. by 1 if the value T is measured in terms of number of Beacon Intervals) and sets the NPCA PCH Change Timer field in the Advanced NPCA Operation Information field in the NPCA Operation Information field in the UHR Operation element in the next Beacon frame it transmits to the new value of T (i.e., sets NPCA PCH Change Timer field to T−1). The NPCA AP sets the NPCA Primary Channel field in the Advanced NPCA Operation Information field in the NPCA Operation Information field in the UHR Operation element in the same Beacon frame to the current NPCA Primary Channel. Once the value T reaches 0, the NPCA AP sets the NPCA PCH Change Timer field in the Advanced NPCA Operation Information field in the NPCA Operation Information field in the UHR Operation element in the next Beacon frame it transmits to 0, and sets the NPCA Primary Channel field in the Advanced NPCA Operation Information field in the NPCA Operation Information field in the UHR Operation element in the next Beacon frame to the new NPCA Primary Channel. The non-AP STA detects that T=0 and switches to the new NPCA PCH.

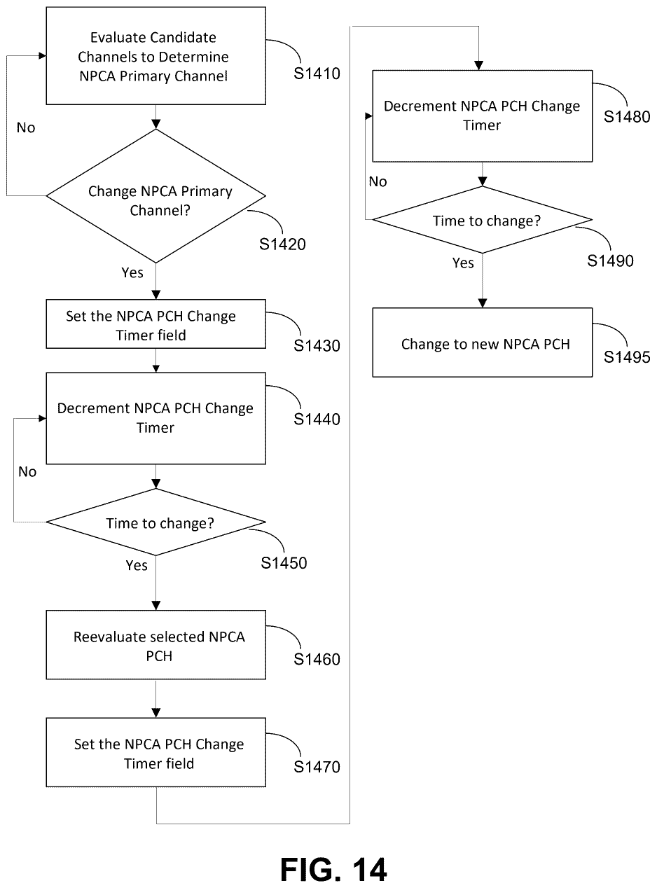

FIG. 14 illustrates a second method at the NPCA AP for changing the NPCA Primary Channel according to an embodiment of the present principles.

Steps S1410-1450 correspond to steps S1110-S1150 already described with reference to FIG. 11.

When it is time to change the NPCA PCH (i.e. “Yes” in S1450), in step S1460, the NPCA AP reevaluates the selected candidate channel to confirm that it is still a good candidate. In the following, it is assumed that this is the case (but if it is not, then the method can go back to step S1410).

In step S1470, the NPCA AP sets the NPCA PCH Timer field to a new value T1<T.

Steps S1480-S1490 are the same as steps S1440-1450.

In step S1495, the NPCA AP switches to the new NPCA PCH, as already described.

However, in a variant, the method essentially returns to step S1460 to reevaluate the selected candidate channel again to confirm the selected channel is still a good candidate. If this is not the case, the NPCA AP can set the NPCA PCH Timer field to a value T2<T1. The method can if needed iterate the reevaluation multiple times (such as M times); the NPCA PCH Timer field values can be made smaller for each iteration.

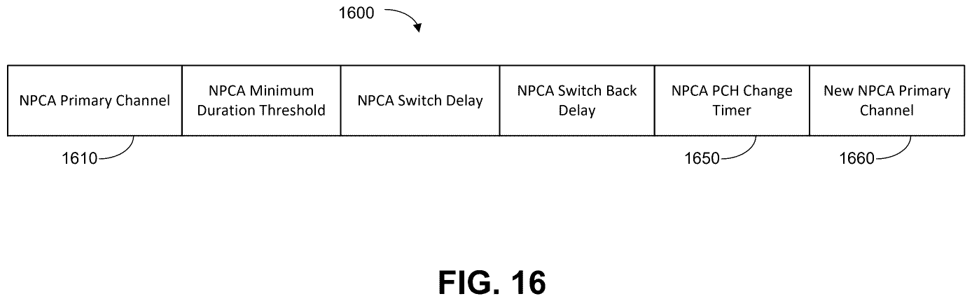

FIG. 16 illustrates an example Advanced NPCA Operation Information field format 1600 for NPCA SOOC Operation. This second example includes the four left-most fields of the first example and also includes a NPCA PCH Change Timer field 1650 and a New NPCA Primary Channel field 1660.

Using the second example Advanced NPCA Operation Information field format, the NPCA AP may (additionally or alternatively) set the NPCA PCH Change Timer field 1650 to a value such as 0 to indicate that the NPCA PCH in the NPCA Primary Channel field 1610 is the NPCA PCH currently in use and that no change is scheduled for the NPCA PCH. The NPCA AP may set the NPCA PCH Change Timer field 1650 to a value such as T to indicate that the NPCA PCH indicated in the NPCA Primary Channel field 1610 is the NPCA PCH currently in use and the NPCA PCH indicated in the New NPCA Primary Channel field 1660 will become the primary channel in use once the countdown indicated in the NPCA PCH Change Timer field 1650 becomes 0 (but, as already explained, different methods for indicating the time of change, such as counting up or counting to a specific value, may also be used). When the NPCA PCH Change Timer field 1650 is set to 0 after a countdown, the NPCA AP sets the NPCA Primary Channel field 1610 to the new NPCA primary channel and sets the New NPCA Primary Channel field 1660 to a reserved value such as 0.

The NPCA AP may evaluate the candidate channels within the BSS operating channel width to be selected as an NPCA PCH and in case it finds that an NPCA PCH is better (using some evaluation criterion, e.g. lower interference) than the current NPCA PCH, the NPCA AP may set the New NPCA Primary Channel field 1660 to the newly selected NPCA primary channel, set the NPCA PCH Change Timer field 1650 to a value T and decrease this value in the NPCA PCH Change Timer field 1650 in each Beacon frame it transmits until it reaches a value of 0. The NPCA AP may then set the NPCA Primary Channel field 1610 to the new NPCA primary channel, set the New NPCA Primary Channel field to 1660 a reserved value and set the NPCA PCH Change Timer field to 0 in an advanced NPCA Operation Information field in the UHR Operation element included in the Beacon frame.

In essence, when the NPCA PCH Change Timer field 1650 is set to a given value (such as 0), this indicates either that no change is scheduled or that a change has just occurred, and the primary channel indicated in the NPCA Primary Channel field 1610 is the NPCA primary channel that shall be used. On the other hand, when the NPCA PCH Change Timer field 1650 is set to another value such as T, this indicates that a change is scheduled after T units of time, the channel indicated in the NPCA Primary Channel field 1610 is the NPCA primary channel currently in use, and the channel indicated in the in the New NPCA Primary Channel field 1660 is the NPCA primary channel that will be used when the countdown has elapsed and the NPCA PCH Change Timer field 1650 is set to 0.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency trade-offs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a non-access point, non-AP, station, STA, the method comprising:
transmitting, to an AP, a first frame including a first non-primary channel access, NPCA, information field comprising a first capability subfield, wherein the first capability subfield comprises information indicative of a capability of the non-AP STA to switch from a basic service set, BSS, primary channel to a NPCA primary channel that lies outside of a current operating channel width of the non-AP STA and that lies within a BSS channel width of the AP, the current operating channel width including the BSS primary channel;
receiving, from the AP, a second frame including a second NPCA information field comprising a control subfield, wherein the control subfield indicates enablement information for switching from the BSS primary channel to a specific NPCA primary channel outside the current operating channel width of the non-AP STA; and
switching to the specific NPCA primary channel.

2. The method of claim 1, wherein the first frame is one of an association request frame, a reassociation request frame, a probe request frame, a control frame and an action frame.

3. The method of claim 1, wherein the second frame is one of an association response frame, a reassociation response frame, a probe response frame, a control frame and an action frame.

4. The method of claim 1, wherein the first NPCA information field comprises a delay field, the delay field indicating a time delay, wherein the switching to the specific NPCA primary channel is performed within the time delay.

5. A non-access point, non-AP, station, STA, comprising at least one processor configured to:
transmit, to an AP, a first frame including a first non-primary channel access, NPCA, information field comprising a first capability subfield, wherein the first capability subfield comprises information indicative of a capability of the non-AP STA to switch from a basic service set, BSS, primary channel to a NPCA primary channel that lies outside of a current operating channel width of the non-AP STA and that lies within a BSS channel width of the AP, the current operating channel width including the BSS primary channel;
receive, from the AP, a second frame including a second NPCA information field comprising a control subfield, wherein the control subfield indicates enablement information for switching from the BSS primary channel to a specific NPCA primary channel outside the current operating channel width of the non-AP STA; and
switch to the specific NPCA primary channel.

6. The non-AP STA of claim 5, wherein the first frame is one of an association request frame, a reassociation request frame, a probe request frame, a control frame and an action frame.

7. The non-AP STA of claim 5, wherein the second frame is one of an association response frame, a reassociation response frame, a probe response frame, a control frame and an action frame.

8. The non-AP STA of claim 5, wherein the first NPCA information field comprises a delay field, the delay field indicating a time delay, wherein the switching to the specific NPCA primary channel is performed within the time delay.

9. A method performed by an access point, AP, the method comprising:
receiving, from a non-AP station, STA, a first frame including a first non-primary channel access, NPCA, information field comprising a first capability subfield, wherein the first capability subfield comprises information indicative of a capability of the non-AP STA to switch from a basic service set, BSS, primary channel to a NPCA primary channel that lies outside of a current operating channel width of the non-AP STA and that lies within a BSS channel width of the AP, the current operating channel width including the BSS primary channel;
transmitting, to the non-AP STA, a second frame including a second NPCA information field comprising a control subfield, wherein the control subfield indicates enablement information for switching from the BSS primary channel to a specific NPCA primary channel outside the current operating channel width of the non-AP STA; and
switching to the specific NPCA primary channel.

10. The method of claim 9, wherein the first management frame is one of an association request frame, a reassociation request frame, a probe request frame, a control frame and an action frame.

11. The method of claim 9, wherein the second management frame is one of an association response frame, a reassociation response frame, a probe response frame, a control frame and an action frame.

12. The method of claim 9, wherein the first NPCA information field comprises a delay field, the delay field indicating a time delay, wherein the switching to the specific NPCA primary channel is performed within the time delay.

13. An access point, AP, comprising at least one processor configured to:
receive, from a non-AP station, STA, a first frame including a first non-primary channel access, NPCA, information field comprising a first capability subfield, wherein the first capability subfield comprises information indicative of a capability of the non-AP STA to switch from a basic service set, BSS, primary channel to a NPCA primary channel that lies outside of a current operating channel width of the non-AP STA and that lies within a BSS channel width of the AP, the current operating channel width including the BSS primary channel;
transmit, to the non-AP STA, a second frame including a second NPCA information field comprising a control subfield, wherein the control subfield indicates enablement information for switching from the BSS primary channel to a specific NPCA primary channel outside the current operating channel width of the non-AP STA; and
switch to the specific NPCA primary channel.

14. The AP of claim 13, wherein the first management frame is one of an association request frame, a reassociation request frame, a probe request frame, a control frame and an action frame.

15. The AP of claim 13, wherein the second management frame is one of an association response frame, a reassociation response frame, a probe response frame, a control frame and an action frame.

16. The AP of claim 13, wherein the first NPCA information field comprises a delay field, the delay field indicating a time delay, wherein the switching to the specific NPCA primary channel is performed within the time delay.
